(19) United States
(12) Patent Application Publication
(10) Pub. No.: US 2008/0055566 A1
(43) Pub. Date: Mar. 6, 2008

(54) MOBILE TERMINAL EQUIPPED WITH OPTICAL MODULATOR-BASED PROJECTOR

(75) Inventor: Sang Kyeong Yun, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/848,069

(22) Filed: Aug. 30, 2007

(30) Foreign Application Priority Data
Aug. 30, 2006 (KR) 1020060082841

(51) Int. Cl. G03B 21/14; G03B 21/28

(52) U.S. Cl. 353/82; 353/122; 353/99

(57) ABSTRACT

Disclosed herein is a mobile terminal equipped with an optical modulator-based projector. The mobile terminal includes a control system, a projection control system, and an optical modulation system. The optical modulation system produces light and produces an image by modulating the produced light in response to the drive control signal from the projection control system, and scans the produced image onto an internal display unit while projecting the produced image onto the internal display unit.

### CROSS REFERENCE TO RELATED APPLICATION

This application claims the benefit of Korean Patent Application No. 10-2006-0082841, filed on Aug. 30, 2006, entitled “Mobile Unit using the Projector of Optical Modulator,” which is hereby incorporated by reference in its entirety into this application.

### BACKGROUND OF THE INVENTION

1. Field of the Invention

The present invention relates to a mobile terminal equipped with an optical modulator-based projector, which produces an image by modulating light, emitted from a light source, using an optical modulator, and displays the image by scanning the produced image in such a way as to project the produced image onto an external screen and, or scanning the produced image in such a way as to project the produced image onto an internal display unit.

2. Description of the Related Art

Recently, with the rapid development of the electronic industry and information and communication technology, various types of textual and visual information is being processed using terminals, such as desktop Personal Computers (PCs), notebook PCs, and mobile phones, in almost all industries. In particular, with the increased utilization of information via the Internet, mobile phones, in addition to desktop PCs and notebook PCs, are connected to the Internet and process information in conjunction with the Internet.

In particular, as high-speed Internet services become available on desktop PCs, notebook PCs and mobile phones, the demand for high-quality image processing is increasing.

However, terminals, such as desktop PCs, notebook PCs and mobile phones, are disadvantageous in that viewing ranges and readability are limited because monitors having specific dimensions are integrated with terminal bodies.

### SUMMARY OF THE INVENTION

Accordingly, the present invention has been made keeping in mind the above problems occurring in the prior art, and the present invention is intended to provide a mobile terminal equipped with an optical modulator-based projector, which is capable of producing a linear image by modulating light, emitted from a light source, using an optical modulator, and displaying a high-quality image by scanning the produced image in such a way as to project the produced image onto an internal display unit.

Additionally, the present invention is intended to provide a mobile terminal equipped with an optical modulator-based projector, which is capable of producing an image by modulating light, emitted from a light source, using an optical modulator, and projecting the produced image on an external screen (an external display unit), thereby satisfying the demand for a small size and low power consumption required by mobile terminals.

In order to accomplish the above object, the present invention provides a mobile terminal equipped with an optical modulator-based projector, including a control system for outputting an internal display unit projection control signal and image data, a projection control system for receiving the image data from the control system, and producing and outputting a drive control signal based on the image data, and an optical modulation system for producing light and producing an image by modulating the produced light in response to the drive control signal from the projection control system, and scanning the produced image onto an internal display unit while projecting the produced image onto the internal display unit.

In an embodiment, the optical modulation system scans the produced image onto an external screen while projecting the produced image onto the external screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a folding mobile terminal equipped with a mobile projector according to an embodiment of the present invention, with part thereof being cut away therefrom;

FIG. 2 is a block diagram of a mobile terminal provided with an internal optical modulator-based projector according to an embodiment of the present invention;

FIG. 3 is a block diagram showing the internal construction of the projection drive unit of FIG. 2;

FIG. 4A is a perspective view showing the diffractive optical modulator of FIG. 2, and FIG. 4B is a plan view showing the diffractive optical modulator of FIG. 2;

FIG. 5 is a diagram showing an embodiment of the light path changing unit of FIG. 2; and

FIGS. 6A to 6C are diagrams showing embodiments of the internal display unit of FIG. 2.

### DESCRIPTION OF THE PREFERRED EMBODIMENTS

A mobile terminal equipped with an optical modulator-based projector according to an embodiment of the present invention is described with reference to the accompanying drawings below.

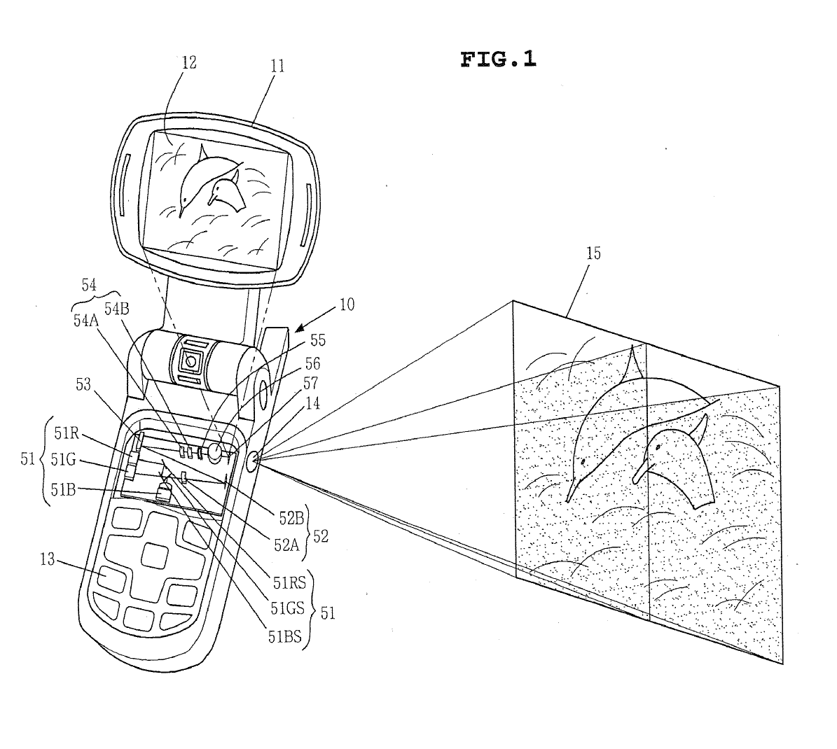

FIG. 1 is a perspective view showing a folding mobile terminal 10 equipped with a mobile projector according to an embodiment of the present invention, with part thereof being cut away therefrom. Although the folding mobile terminal 10 is described by way of example here, it will be apparent to those skilled in the art that the description can be applied to a sliding mobile terminal.

Referring to FIG. 1, the folding mobile terminal 10 equipped with a mobile projector according to the present embodiment of the present invention displays an image in an internal projection mode (here, the term “internal projection mode” refers to a mode in which an image is displayed on an internal display unit) or in an external projection mode (here, the term “external projection mode” refers to a mode in which an image is displayed on an external screen, which is selected by a user through a keypad 13) in such a way as to produce an image by operating the provided mobile projector and display the image by projecting the produced image onto an internal display unit 12 contained in a cover part 11 or by projecting the produced image onto an external screen 15 through an opening located on the right side of a terminal body.

Here, the mobile projector includes an optical modulation system that, as shown in the partially cutaway part of FIG. 1, includes a light source unit 51 for producing red, green and blue light, and causing the produced red, green and blue light to have a single path, an illumination optical unit 52 for projecting the light, emitted from the light source unit 51, onto the diffractive optical modulator 53, a diffractive optical modulator 53 for producing diffracted light having a plurality of diffraction orders by modulating incident light, thereby producing an image using the diffracted light, a filter unit 54 for passing diffracted light having at least one desired diffraction order, selected from the diffracted light having a plurality of diffraction orders produced by the diffractive optical modulator 53, therethrough, a projection optical unit 55 for magnifying and projecting the diffracted light passed through the filter unit 54, a scanning unit 56 for producing an image by displaying an image of the diffracted light, magnified and projected by the projection optical unit 55, on the internal display unit 12 or by scanning the diffracted light onto the external screen 15, and a light path changing unit 57 including a reflective surface for changing the light path of the diffracted light so that it is directed toward the internal display unit 12.

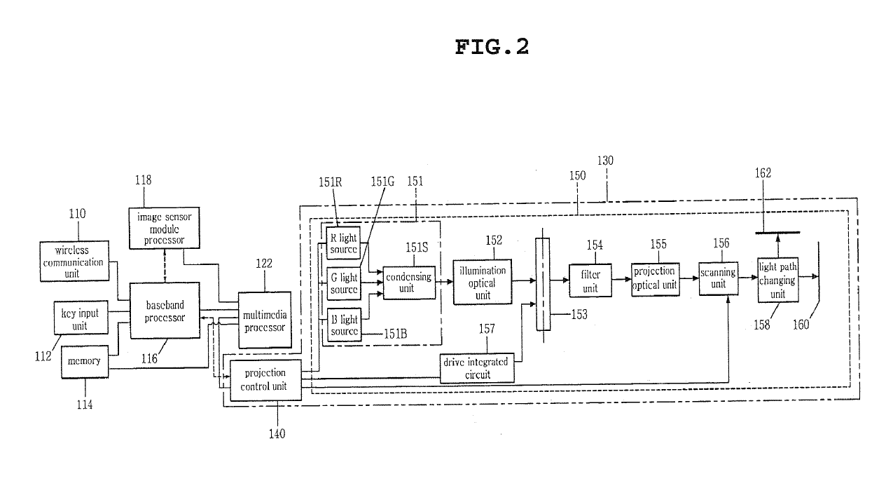

Here, the light source unit 51 includes a red (R) light source 51R, a green (G) light source 51G, a blue (B) light source 51B, and a condensing unit 51S. The condensing unit 51S includes a mirror 51RS for reflecting R light so as to condense R light, a dichroic mirror 51GS for reflecting R light and passing G light therethrough so as to condense R light and G light, and a dichroic mirror 51BS for passing R light and G light therethrough and reflecting B light so as to condense R light, G light and B light. As shown in FIG. 2, the optical modulation system produces images under the control of a projection control unit 140, and the projection control unit 140 is controlled by the multimedia processor 122. Of course, in the case where the multimedia processor 122 is not provided, the projection control unit 140 is controlled by the baseband processor 116, as indicated by the dotted arrow in FIG. 2.

Meanwhile, if the mobile terminal is not a mobile phone, the baseband processor 116 can be replaced with another type of processor. That is, the term “baseband processor 116” includes other types of processors that can be used in a mobile phone and other types of mobile terminals.

FIG. 2 is a block diagram of a mobile terminal provided with an internal mobile projector according to an embodiment of the present invention.

As shown in FIG. 2, the portable terminal provided with an internal mobile projector according to the present embodiment of the present invention includes a wireless communication unit 110 for conducting wireless communication, a key input unit 112 for inputting information, memory 114 for storing image data, a baseband processor 116 for controlling a multimedia processor 122 so that an image is projected onto an internal display unit 160 or an external screen 162, an image sensor module processor 118 for processing an image from a provided camera and sending the processed image data to a multimedia processor, a multimedia processor 122 for storing an image, input from the image sensor module processor 118, in the memory 114 or sending the image to the projection control unit 140 for projection, and, when a image projection signal is input from the baseband processor 116, reading the image data from the memory 114 and sending the image data to the projection control unit 140 for projection onto the internal display unit 160 or the external screen 162, and a mobile projector 130 for producing an image based on the image data from the multimedia processor 122, magnifying the produced image and projecting the magnified image onto the internal display unit 160 or the external screen 162. Here, the multimedia processor 122 and the baseband processor 116 are collectively referred to as a “terminal control system.”

Meanwhile, the dotted arrows of FIG. 2 indicate the signal flow of image data in the case where the multimedia processor 122 is not provided. Referring to FIG. 2, in the case where the multimedia processor 122 is not provided, the image sensor module processor 118 processes image data from a camera or the like, and sends the processed image data to the baseband processor 116. The baseband processor 116 stores image data, input from the image sensor module processor 118, in the memory 114, and sends image data to the projection control unit 140 for projection. Furthermore, the baseband processor 116 reads the image data from the memory 114 and sends the image data to the projection control unit 140, so that an image is projected onto the internal display unit 160 and/or external screen 162.

Here, the mobile projector 130 according to the present invention includes a projection control unit 140 for controlling the optical modulation system 150 so that the optical modulation system 150 produces an image based on received image data when a projection control signal and the image data are received from the multimedia processor 122 (the baseband processor 116 performs the same function in the case where the multimedia processor 122 is not provided), and an optical modulation system 150 for producing an image based on the projection control signal and the image data received from the projection control unit 140, and displaying the produced image on the internal display unit 160 and/or external screen 162.

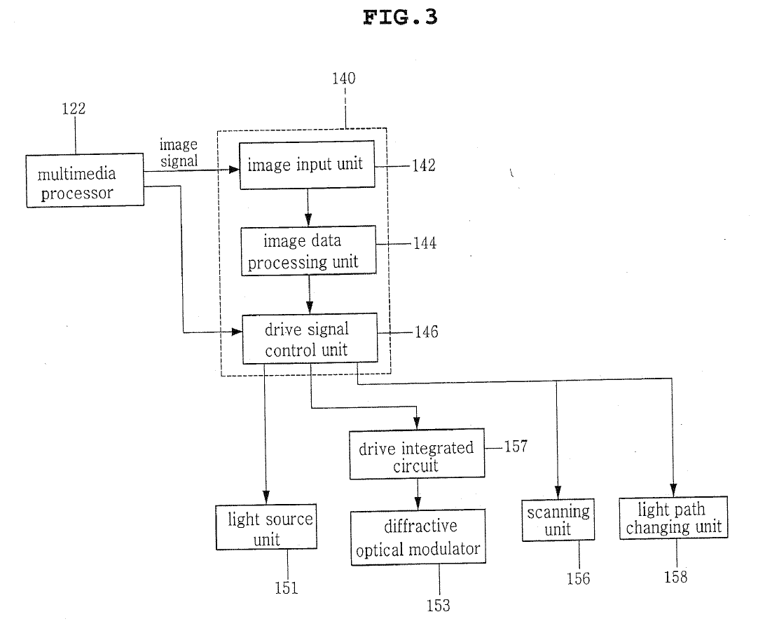

The projection control unit 140, as shown in FIG. 3, includes an image input unit 142, an image data processing unit 144, and a drive signal control unit 146.

Furthermore, the optical modulation system 150 includes a light source unit 151 for producing and emitting RGB light, an illumination optical unit 152 for causing light, emitted from the light source unit 151, to enter the diffractive optical modulator 153, a diffractive optical modulator 153 for producing a linear image by diffracting light incident from the illumination optical unit 152 (that is, the diffractive optical modulator 153 produces diffracted light having a plurality of diffraction orders by diffracting light incident from the illumination optical unit 152, in which case diffracted light having at least one diffraction order, selected from the diffracted light having a plurality of diffraction orders, forms a desired image), a filter unit 154 for passing the diffracted light having at least one diffraction order, selected from the diffracted light having a plurality of diffraction orders produced by the diffractive optical modulator 153, therethrough, a projection optical unit 155 for magnifying an image formed by the diffracted light passed through the filter unit 154, and projecting the image, a scanning unit 156 for scanning an image onto the internal display unit 160 or the external screen 162, a light path changing unit 158 for converting a light path so that the diffracted light emitted from the scanning unit 156 is directed toward the external screen 162, and a drive integrated circuit 157 for generating a drive signal and driving the diffractive optical modulator 153 in response to a projection control signal and image data from the projection control unit 140.

Meanwhile, the image input unit 142 of the projection control unit 140 receives image data from the multimedia processor 122. Alternatively, in the case where the multimedia processor 122 is not provided, the image input unit 142 receives image data directly from the baseband processor 116.

The image data processing unit 144 of the projection control unit 140 converts laterally input image data into vertically arranged image data by performing the data transposition of converting laterally arranged image data into vertically arranged data, and outputs the resulting data. The reason why the image data processing unit 144 is required to perform such transposition is that the optical modulation system 150 using the diffractive optical modulator 153 is configured to perform scanning and display in a lateral direction because a plurality of pixels is arranged in a vertical direction.

When a projection control signal, requiring the performance of a projection function, and an image data-type signal, indicating whether an image must be projected onto the internal display unit 160, the external screen 162, or both the internal display unit 160 and the external screen 162, are received from the multimedia processor 122 and laterally transposed image data is received from the image data processing unit 144, the drive signal control unit 146 of the projection control unit 140 controls the light source unit 151 so that it produces light and sends the projection control signal and the image data to the drive integrated circuit 157 so that the diffractive optical modulator 153 produces an image using diffracted light.

Furthermore, when an image data type signal, indicating that an image must be displayed on the external screen 162, is received from the multimedia processor 122, the drive signal control unit 146 controls the light path changing unit 158 so that a light path, previously directed toward the internal display unit 160, is directed toward the external screen 162.

Meanwhile, the light source unit 151 of the optical modulation system 150 includes a plurality of light sources, for example, an R light source 151R, a G light source 151G, and a B light source 151B, and includes the condensing unit 151S, so that it condenses and then emits a plurality of beams of light. In the case of a single panel-type optical modulation system, like that described in the embodiment of the present invention, that is, the system in which only one diffractive optical modulator 153 is employed, when the light source unit 151 time-divides and then emits R light, G light and B light, it is not necessary to provide a separate color wheel (a device capable of time-dividing a multibeam according to color) upstream or downstream of the diffractive optical modulator 153. Of course, when the light source unit 151 emits a plurality of beams of light in the form of a multibeam, that is, the light source unit 151 emits a plurality of beams of light without time division, it is necessary to provide a separate color wheel (a device capable of time-dividing a multibeam according to color) upstream or downstream of the diffractive optical modulator 153.

Here, the condensing unit 151S may be formed of one reflective mirror (51RS in FIG. 1) and two dichroic mirrors (51GS and 51BS in FIG. 1) when, for example, the R light source 151R, the G light source 151G and the B light source 151B are used, in which case B light, G light and R light are condensed into a multibeam, thereby being able to form a single illumination system.

Thereafter, the illumination optical unit 152 converts light, emitted from the light source unit 151, into linear parallel light, and causes the linear parallel light to enter the diffractive optical modulator 153.

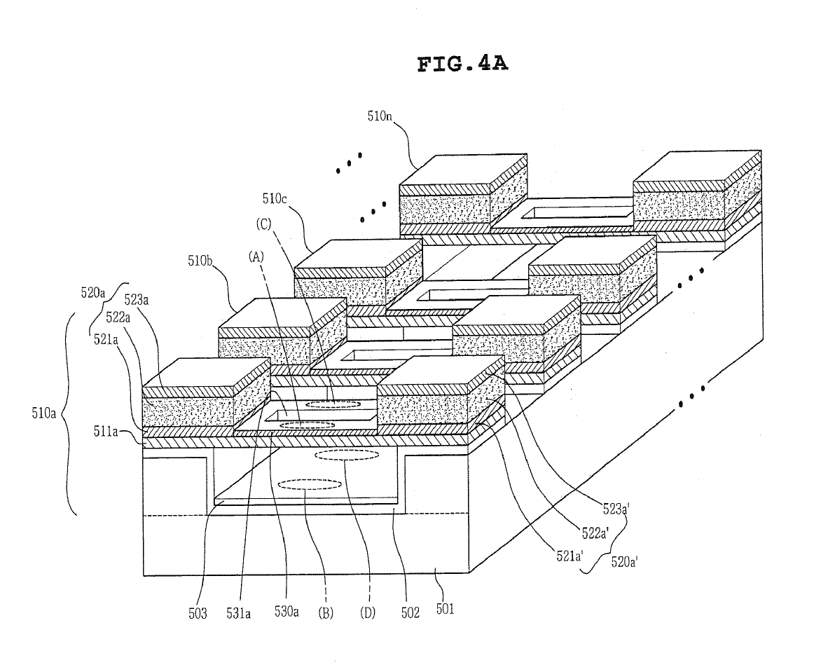

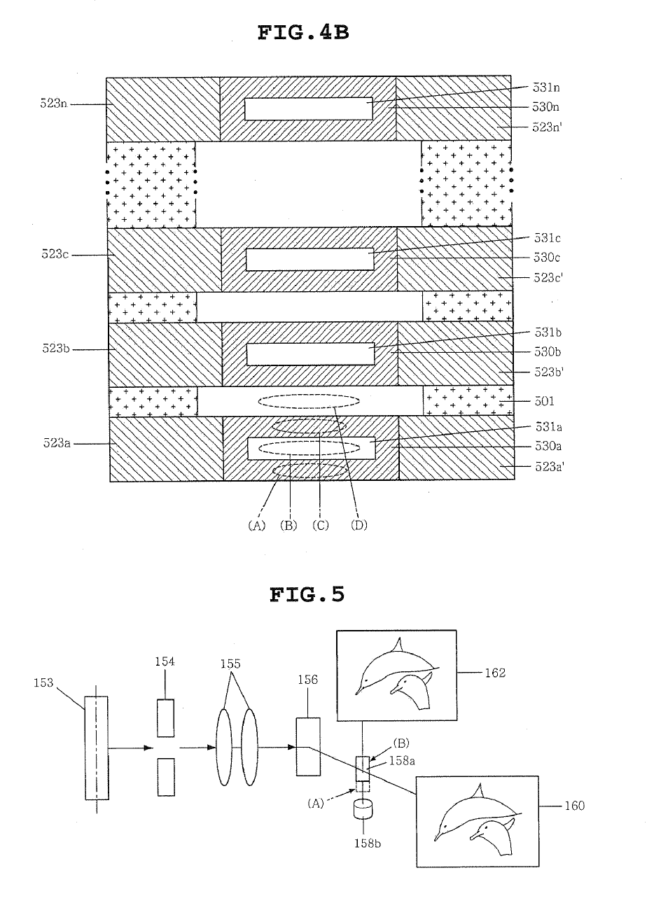

When linear parallel light is incident from the illumination optical unit 152, the diffractive optical modulator 153 produces diffracted light having a plurality of diffraction orders through modulation, thereby producing an image (of course, an image can be formed using diffracted light having one or more diffraction orders selected from diffracted light having a plurality of diffraction orders). An example of such a diffractive optical modulator 153 is an open hole-based diffractive optical modulator, which is shown in FIG. 4A. As shown in FIG. 4A, the open hole-based diffractive optical modulator according to the present invention includes a silicon substrate 501, an insulating layer 502, a lower micromirror 503, and a plurality of elements 510a˜510n. Although the insulating layer and the lower micromirror are constructed as separate layers, the insulating layer itself may be allowed to function as the lower micromirror when the insulating layer has the property of reflecting light.

The silicon substrate 501 has a recess so as to provide air space to elements 510a˜510n. The insulating layer 502 is disposed on the silicon substrate 501. The lower micromirror 503 is deposited on the insulating layer 502. The lower surfaces of the elements 510a˜510n are attached to both sides of the insulating layer 502 outside the recess. The silicon substrate 501 may be made of a single material, such as Si, Al2O3, ZrO2, Quartz, or SiO2, or a base portion and an upper portion (which are indicated by dotted lines in FIG. 4A) may be respectively made of different materials.

The lower micromirror 503 is deposited above the silicon substrate 501, and diffracts incident light by reflecting it. The material of the lower micromirror 503 may be metal, such as Al, Pt, Cr, or Ag.

An element 510a (although only the element 510a is described herein, the remaining elements have the same construction and operation) has a ribbon shape. The element 510a includes a lower support 511a, both sides of the bottom of which are attached beside the recess of the silicon substrate 501, so that the central portion of the lower support 511a can be spaced apart from the recess of the silicon substrate 501.

Piezoelectric layers 520a and 520a′ are provided on both sides of the lower support 511a. The actuation force of the elements 510a is provided by the contraction and expansion of the piezoelectric layers 520a and 520a′.

The material of the lower support 511a may be Si oxide (for example, SiO₂), Si nitride (for example, Si₃N₄), a ceramic substrate (for example, Si, ZrO₂, or Al₂O₃), or Si carbide. The lower support 511a may be omitted if not needed.

Each of the right and left piezoelectric layers 520a and 520a′ includes a lower electrode layer 521a or 521a′ configured to provide piezoelectric voltage, a piezoelectric material layer 522a or 522a′ disposed on the lower electrode layer 521a or 521a′ and configured to contract and expand and thus generate vertical actuation force in response to voltage applied to both surfaces thereof, and an upper electrode layer 523a or 523a′ disposed on the piezoelectric material layer 522a or 522a′ and configured to apply piezoelectric voltage to the piezoelectric material layer 522a or 522a′. When voltage is applied to the upper electrode layer 523a or 523a′ and the lower electrode layer 521a or 521a′, the piezoelectric material layer 522a or 522a′ contracts and expands, and thus moves the lower support 511a vertically.

The material of the electrodes 521a, 521a′, 523a, and 523a′ may be Pt, Ta/Pt, Ni, Au, Al, RuO₂, or the like. They are deposited through sputtering or evaporation in a thickness ranging from 0.01 to 3 μm.

Meanwhile, the upper micromirror 530a is deposited on the center portion of the lower support 511a, and an open hole 531a is formed through the upper micromirror 530a and the lower support 511a. The open hole 531a preferably has a rectangular shape, but may have any closed curve, such as a circular shapes or an elliptical shape. If the lower support 511a is made of light reflecting material, it is not necessary to deposit a separate upper micromirror, rather, the lower support 511a is made to function as the upper micromirror.

The open hole 531a allows light incident on the element 510a to be incident on the portion of the lower micromirror 503 corresponding to the portion of the upper micromirror 530a through which the open hole 531a is formed, thereby allowing the lower micromirror 503 and the upper micromirror 530a to form a pixel.

That is, as an example, the portion A of the upper micromirror 530a, through which the open hole 531a is formed, and the portion B of the lower micromirror 503 may form one pixel.

At this time, the incident light, which passes through the portion of the upper micromirror 530a through which the open hole 531a is formed, can be incident on the corresponding portion B of the lower micromirror 503. When the distance between the upper micromirror 530a and the lower micromirror 503 is an odd multiple of λ/4, maximally diffracted light is produced.

In the open hole-based diffractive optical modulator of FIG. 4A, the open hole 531a is formed to have a rectangular shape and to have a longitudinal side that is parallel to the direction in which the element 510a crosses the silicon substrate 501. By doing so, when sufficient space between the elements 510a˜510n is ensured, the space (D) between the elements 510a˜510n can be utilized, as seen from the plan view of FIG. 4B. That is, light that is passed through the space (D) between the elements 510a˜510n and reflected from the lower micromirror 503 may be caused to be diffracted along with the light reflected from the adjacent region (C) of the upper micromirror 530a. Of course, when the height between the portion of the lower micromirror 503, located below the space (D) between the elements 510a˜510n, and the adjacent region (C) of the upper micromirror 530a is an odd multiple of λ/4 if the wavelength of incident light is λ, diffracted light having maximal light intensity is produced.

Thereby, the regions (A), (B), (C), and (D) of FIGS. 4A and 4B may be made to form one pixel, with the result that optical loss can be reduced, thus being able to increase optical efficiency.

Referring to FIGS. 4A and 4B, the regions (A) and (C) of the upper micromirror 530a function as reflective surfaces for reflecting incident light. Furthermore, the region (B) of the lower micromirror 503 corresponding to the open hole 531a of the upper micromirror 530a functions as a reflective surface for reflecting incident light that has passed through the open hole 531a, and the region (D) corresponding to the space between the element 510a and its neighboring element 510b functions as a reflective surface for reflecting incident light that has passed through the space.

Here, the widths of the reflective regions (A), (B), (C), and (D) are the same so that a pixel can be efficiently formed. Of course, it is preferable that the width of the reflective regions (B) and (D) be slightly wider than that of the reflective regions (A) and (B). The reason for this is that optical loss occurs both when incident light passes through the open hole 531a and the space between the elements 510a and 510b and when light reflected from the lower micromirror 503 passes through the open hole 531a and the space between the elements 510a and 510b, so that it is necessary to slightly increase the latter width so as to compensate for the optical loss. As an example, the width of the reflective regions (A) and (C) is 3.9 μm, while the width of the reflective regions (B) and (D) is 4.1 μm.

Meanwhile, the filter unit 154 includes, for example, a Fourier lens (54A in FIG. 1) and a dichroic filter (54B in FIG. 1), and separates diffracted light according to the diffraction order and passes diffracted light having at least one diffraction order therethrough.

The projection optical unit 155 projects an image, and scans diffracted light incident from the scanning unit 156 onto the internal display unit 160, so that an image is formed on the internal display unit 160, or scans the diffracted light onto the external screen 162, so that an image is formed on the external screen 162, thereby allowing the image to be viewed by a viewer.

Meanwhile, diffracted light formed by the diffractive optical modulator 153 has a plurality of diffraction orders. If diffracted light having a 0th diffraction order is used, a large amount of output can be achieved using low power and power consumption can be reduced, so that it is easy to apply a diffractive optical modulator to mobile terminals requiring low power. Furthermore, if 0th-order diffracted light is selected from diffracted light produced by the diffractive optical modulator 153 and is then used, 0th-order diffracted light is not spread, unlike +1st-order diffracted light and −1st-order diffracted light, so that a large-sized lens system, which is used to condense diffracted light when +1st-order diffracted light and −1st-order diffracted light are employed, is not necessary, thereby enabling realization of a small size.

Furthermore, since 0th-order diffracted light has a greater focal depth than +1st-order diffracted light or −1st-order diffracted light, it is easy to use a diffractive optical modulator in a mobile terminal to which the external screen 162 is not fixed. Here, the term “focal depth” refers to information indicating the distance in front of or behind a focused object to which a clear image is attained. Since 0th-order diffracted light is a single beam, 0th-order diffracted light has a greater focal depth than 1st- or higher order diffracted light, which is formed by condensing + order diffracted light and − order diffracted light. That is, when 1st- or higher order diffracted light is used, a focal point is formed while + order diffracted light and − order diffracted light cross each other, so that the focal depth thereof is shorter. Accordingly, in an application in which the external screen 162 is not fixed but a user arbitrarily sets the screen 162 and performs focusing, unlike a mobile terminal, a long focal depth is not required, and 0th-order diffracted light satisfies the requirements.

Meanwhile, when a light path changing control signal is received from the projection control unit 140, the light path changing unit 158 directs a light path, previously directed from the scanning unit 156 to the internal display unit 160, to the external screen 162.

An embodiment of the light path changing unit 158 is shown in FIG. 5. Referring to FIG. 5, the light path changing unit 158 includes a reflective mirror 158a for directing the path of diffracted light, scanned by the scanning unit 156, from the internal display unit 160 to the external screen 162, and a mirror moving unit 158b for changing a projection mode to an external projection by moving the reflective mirror 158a from location (A) in an internal projection mode to location (B).

When a light path changing control signal is received from the projection control unit 140, the mirror moving unit 158b changes a projection mode from an internal projection mode to an external projection mode by changing the light path in such a way as to change the location of the reflective mirror 158a from location (A), indicated by the dotted line, to location (B).

Of course, although an internal projection mode and an external projection mode are separate from each other here, the internal projection mode and the external projection mode may be implemented at the same time. When the reflective mirror 158a is implemented such that it is divided into a total reflection region, a semi-transmissive region and a transmissive region in an embodiment for doing so, it is possible to implement an internal projection mode, a combined internal and external projection mode, and an external projection mode. That is, in the external projection mode, incident diffracted light is all reflected to the external screen 162 via the total reflection region of the reflective mirror 158a, so that an image is displayed only on an external screen 162. In the internal and external projection mode, part of the incident diffracted light is directed to the internal display unit 160 and the remaining part thereof is directed to the external screen 162 via the semi-transmissive region of the reflective mirror 158a, so that an image is displayed on both the internal display unit 160 and the external screen 162. In the external projection mode, incident diffracted light is transmitted to the internal display unit 160 via the transmissive region of the reflective mirror 158a, so that an image is displayed on the internal display unit 160.

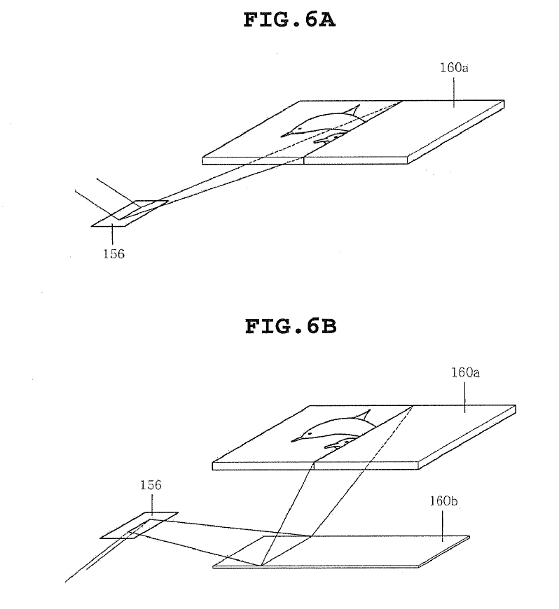

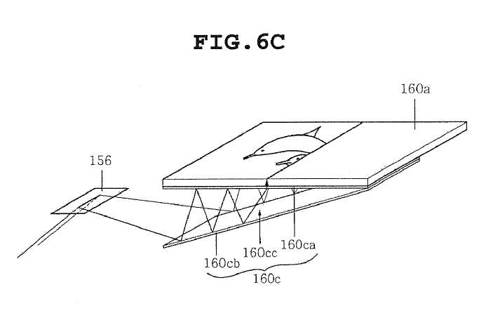

Meanwhile, there are many methods of displaying an image on the internal display unit 160 using the scanning unit 156. The embodiments of the methods are shown in FIGS. 6A to 6C.

As an example, referring to FIG. 6A, implementation may be made such that a two-dimensional image is formed in such a way that the scanning unit 156 scans diffracted light onto the external window 160a (a surface on which an image is displayed so that a user can view the image) of the internal display unit 160 by projecting it onto the external window 160a.

As an example, referring to FIG. 6B, the internal display unit 160 includes an external window 160a for displaying an image so that a user can view the image, and a reflective mirror 160b disposed on one side of the external window 160a to face a side surface of the external window 160a. When the internal display unit 160 is provided with the reflective mirror 160b as described above, unlike that of the embodiment shown in FIG. 6A, the scanning unit 156 scans diffracted light onto the reflective mirror 160b by indirectly projecting the diffracted light onto the reflective mirror 160b rather than scanning diffracted light onto the external window 160a by directly projecting the diffracted light on the external window 160a, so that the reflective mirror 160b performs scanning by reflecting the diffracted light onto the external window 160a, with the result that an image is displayed on the external window 160a. That is, when the scanning unit 156 performs scanning by projecting diffracted light onto the reflective mirror 162b, the reflective mirror 162b performs scanning by performing projection in such a way as to reflect incident diffracted light to the external window 160a, with the result that an image is displayed on the external window 160a.

As still another example, referring to FIG. 6C, the internal display unit 160 includes an external window 160a for displaying an image so that a user can view an image, and a wave guide 160c attached to one side of the external window 160a and configured to guide incident light entering through an opening at one end of the wave guide 160c.

Here, the cross section of the wave guide 160c has a rectangular shape, and the size of the cross section becomes smaller in a downstream direction. The wave guide 160c includes a transmissive sidewall 160ca for passing light having an angle larger than a critical angle therethrough, and a reflective sidewall 160cb for reflecting all incident light. The transmissive sidewall 160ca of the wave guide 160c is in contact with the external window 160a on the outside surface thereof. Of course, rather than separately constructing the external window 160a and the transmissive sidewall 160ca, they may be constructed in a single unit.

When diffracted light enters through the opening at one end of the wave guide 160c, the incident diffracted light propagates through the waveguide path 160cc of the wave guide 160c. In this case, the reflective sidewall 160cb of the wave guide 160c reflects all incident diffracted light and the transmissive sidewall 160ca passes incident diffracted light therethrough when the incident angle thereof is larger than a critical angle, with the result that an image is displayed on the external window 160a. In this case, an operation in which an image is scanned onto and displayed on the external window 160a can be performed in such a way that the scanning unit 156 changes the incident angle of diffracted light entering through the opening of the wave guide 160c. By doing so, the incident light sequentially passes through the transmissive sidewall 160cb while propagating in the waveguiding direction of the wave guide 160c, so that an image is scanned and displayed on the external window 160a, thereby forming a two-dimensional image.

Here, the transmissive sidewall 160ca of the wave guide 160c may be made of PolyMethylMethAcrylate (PMMA) resin or PolyCarbonate (PC) resin, having excellent light transmissivity, so that light projected by the scanning unit 156 can be uniformly transmitted to the external window 160a.

Although the above-described optical modulation system 150 is configured such that an image is produced using a single diffractive optical modulator 153, an image may be produced using three diffractive optical modulators separated according to respective colors (called a three-panel type), in which case three separate illumination optical units are required and a color combination unit is required downstream of the diffractive optical modulators.

Now, with reference to the accompanying drawings, the operation of the mobile terminal equipped with an optical modulator-based projector according to the present invention is described in detail below with the operation divided into an internal projection mode and an external projection mode.

1. Internal Projection Mode

When a user opens a cover part in the case of a folding mobile terminal or slides a slider part in the case of a sliding mobile terminal, the baseband processor 116 sends an internal display unit projection control signal to the multimedia processor 122 so that designated image data that must be projected onto the internal display unit 160 is sent to the projection control unit 140. Here, the internal display unit projection control signal includes a signal indicating the type of image data (that is, a signal indicating that image data must be displayed on the internal display unit 160).

Then, the multimedia processor 122 sends an internal projection control signal based on the internal display unit projection control signal to the drive signal control unit 146, and sends image data, read from the memory 114, to the image input unit 142.

Meanwhile, the image input unit 142 of the projection control unit 140 sends the image data, input from the multimedia processor 122, to the image data processing unit 144, and the image data processing unit 144 transposes the image data and then sends the transposed image data to the drive signal control unit 146.

When the internal projection control signal is input from the multimedia processor 122 and the image data is input from the image data processing unit 144, the drive signal control unit 146 sends a light source control signal based on the input image data to the light source unit 151, so that the light source unit 151 can produce light.

Furthermore, the drive signal control unit 146 outputs a drive control signal based on the image data to the drive integrated circuit 157, and the drive integrated circuit 157, having received the drive control signal, produces a drive signal based on the received drive control signal and operates the diffractive optical modulator 153 using the drive signal.

Furthermore, the drive signal control unit 146 outputs an internal scanning control signal to the scanning unit 156, so that the scanning unit 156 performs scanning, and thus an image is scanned onto the internal display unit 160, thereby displaying an image on the internal display unit 160.

Furthermore, the drive signal control unit 146 sends an internal projection control signal to the light path changing unit 158, and changes a light path so that it is directed to the internal screen 160 when it was previously directed from the scanning unit 156 to the external screen 162.

Meanwhile, in response to a light source control signal from the drive signal control unit 146, the light source unit 151 operates, and sequentially produces and emits R, G and B light.

The illumination optical unit 152 causes the light, produced by the light source unit 151, to enter the diffractive optical modulator 153.

Thereafter, in response to the input drive signal, the diffractive optical modulator 153 operates, and produces diffracted light having a plurality of diffraction orders by modulating light incident from the illumination optical unit 152, thereby producing an image.

As an example, the filter unit 154 passes 0th-order diffracted light, selected from the diffracted light having a plurality of diffraction orders produced by the diffractive optical modulator 153, therethrough, and blocks the remaining diffracted light.

Thereafter, the projection optical unit 155 projects the diffracted light passed through the filter unit 154, and the scanning unit 156 scans an image onto the internal display unit 160 in response to the internal scanning control signal from the drive signal control unit 146, thereby displaying the image on the internal display unit 160.

Here, the scanning unit 156 may be one of various types of scanners, such as an oscillating mirror-type scanner and a rotating head-type scanner.

When the internal projection control signal is input, the mirror moving unit 158b of the light path changing unit 158 changes the location of the reflective mirror 158a to location (A) in the case where the reflective mirror 158a has been placed at location (B), so that the light path, previously directed from the scanning unit 156 to the external screen 162, is directed toward the internal display unit 160.

Meanwhile, in another embodiment of the present invention, the filter unit 154 may be placed at any location downstream of the diffractive optical modulator 153 (may be placed between the scanning unit 156 and the internal display unit 160), or may be included in the scanning unit 156.

Furthermore, the diffractive optical modulator 153 used in the present invention may be a GLV type rather than a piezoelectric type. A piezoelectric optical modulator may be used in the case where there is no open hole. Alternatively, a hybrid-type optical modulator may be used.

Meanwhile, a single beam of light may be used, in which case two-dimensional scanning is performed to produce a two-dimensional image.

The single beam of light can be obtained from a single diode or a diffraction unit that forms a single optical pixel.

2. External Projection Mode

When a user selects an external projection mode for multiplying an image and projecting it onto the external screen 162 using the key input unit 112 (this external projection mode is provided to the user via a menu), and selects image data desired to be displayed on the external screen 162, the baseband processor 116 sends an external screen projection control signal to the multimedia processor 122 so that the image selected by the user is sent to the projection control unit 140.

Then, the multimedia processor 122 sends the external screen projection control signal to the drive signal control unit 146, and the image input unit 142 sends image data read from the memory 114.

Meanwhile, the image input unit 142 of the projection control unit 140 sends the image data, input from the multimedia processor 122, to the image data processing unit 144, and the image data processing unit 144 transposes the image data and then outputs the transposed image data to the drive signal control unit 146.

When the external screen projection control signal is input from the multimedia processor 122 and the image data is input from the image data processing unit 144, the drive signal control unit 146 sends a light source control signal based on the input image data to the light source unit 151, so that the light source unit 151 can produce light.

Furthermore, the drive signal control unit 146 outputs a drive control signal based on the image data to the drive integrated circuit 157, and the drive integrated circuit 157, having received the drive control signal, produces a drive signal based on the received drive control signal and operates the diffractive optical modulator 153 using the drive signal.

Furthermore, the drive signal control unit 146 outputs an external scanning control signal to the scanning unit 156, so that the scanning unit 156 performs scanning, and thus an image is scanned onto the external screen 162, thereby displaying an image on the external screen 162.

Furthermore, the drive signal control unit 146 sends an external projection control signal to the light path changing unit 158, and changes a light path so that it is directed to the internal screen 160 when it was previously directed from the scanning unit 156 to the internal display unit 160.

Meanwhile, in response to a light source control signal from the drive signal control unit 146, the light source unit 151 operates, and sequentially produces and emits R, G and B light.

The illumination optical unit 152 causes the light, produced by the light source unit 151, to enter the diffractive optical modulator 153.

Thereafter, in response to the input drive signal, the diffractive optical modulator 153 operates, and produces diffracted light having a plurality of diffraction orders by modulating light incident from the illumination optical unit 152, thereby producing an image.

As an example, the filter unit 154 passes 0th-order diffracted light, selected from the diffracted light having a plurality of diffraction orders produced by the diffractive optical modulator 153, therethrough, and blocks the remaining diffracted light.

Thereafter, the projection optical unit 155 projects the diffracted light passed through the filter unit 154, and the scanning unit 156 scans an image onto the external screen 162 in response to the external scanning control signal from the drive signal control unit 146, thereby displaying the image on the external screen 162.

When the external projection control signal is input, the mirror moving unit 158b of the light path changing unit 158 changes the light path, previously directed from the scanning unit 156 to the internal display unit 160, so that it is directed to the external screen 162 by changing the location of the reflective mirror 158a from location (A) to location (B).

Meanwhile, although the internal projection mode and the external projection mode have been described as being performed separately, the internal projection mode and the external projection mode may be implemented such that they are performed at the same time.

As described above, the present invention has an advantage in that high-quality images can be realized because images are displayed on an internal display unit using an optical modulator-based projector.

Furthermore, the present invention has an advantage in that limitation to the size of a Liquid Crystal Display (LCD), which exists in a prior art mobile terminal, can be overcome when a projection function is implemented using an optical modulator-based projector.

Furthermore, according to the present invention, a small-sized battery can be employed because a projection function is implemented using a low-power optical modulator.

Moreover, according to the present invention, a small-sized mobile terminal can be realized because a small-sized optical modulator-based projector can be realized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile terminal equipped with an optical modulator-based projector, comprising:
a control system for outputting an internal display unit projection control signal used to display an image on an internal display unit, and outputting image data to be displayed on the internal display unit;
a projection control system for receiving the internal display unit projection control signal and the image data from the control system, and, in response to the input internal display unit projection control signal, outputting an internal projection control signal and producing and outputting a drive control signal based on the image data; and
an optical modulation system for producing light and producing an image by modulating the produced light in response to the drive control signal from the projection control system, and scanning the produced image onto the internal display unit while projecting the produced image onto the internal display unit in response to the internal projection control signal from the projection control system.

2. The mobile terminal as set forth in claim 1, wherein the control system is a baseband processor that outputs the internal display unit projection control signal to the projection control system, and the image data to the projection control system.

3. The mobile terminal as set forth in claim 1, wherein the control system comprises:
a baseband processor for outputting the internal display unit projection control signal; and
a multimedia processor for, when the internal display unit projection control signal is input from the baseband processor, outputting the internal display unit projection control signal to the projection control system, and the image data to the projection control system.

4. The mobile terminal as set forth in claim 1, wherein the image produced by the optical modulation system is formed using 0th-order diffracted light.

5. The mobile terminal as set forth in claim 1, wherein the optical modulation system comprises:
a light source unit for producing and emitting light;
a drive integrated circuit for, when the drive control signal is input from the projection control system, producing and outputting a drive signal;
an optical modulator for, when the drive signal is input from the drive integrated circuit, operating and producing the image by modulating incident light in response to the input drive signal;
an illumination optical unit for causing the light, emitted from the light source unit, to enter the optical modulator;
a projection optical unit for projecting the image emitted from the optical modulator; and
a scanning unit for producing a two-dimensional image by displaying the image, incident from the projection optical unit, on the internal display unit in response to the internal projection control signal from the projection control system.

6. The mobile terminal as set forth in claim 5, wherein the light source unit comprises:
a plurality of light sources for producing light having different colors; and
a condensing unit for condensing the light produced by the plurality of light sources.

7. The mobile terminal as set forth in claim 5, wherein the optical modulator produces a linear image by modulating the light incident from the illumination optical unit.

8. The mobile terminal as set forth in claim 5, wherein the optical modulator diffracts the light incident from the illumination optical unit using a diffractive optical modulator, thereby producing the image using the diffracted light.

9. The mobile terminal as set forth in claim 8, wherein the diffractive optical modulator produces a linear image by modulating the light incident from the illumination optical unit.

10. The mobile terminal as set forth in claim 8, further comprising a filter unit that is disposed downstream of the diffractive optical modulator on a light path extending from the light source unit to the internal display unit, and passes 0th-order diffracted light, selected from the diffracted light having a plurality of diffraction orders produced by the diffractive optical modulator, therethrough.

11. The mobile terminal as set forth in claim 10, wherein the filter unit is included in and integrated with the scanning unit.

12. The mobile terminal as set forth in claim 8, wherein the diffractive optical modulator comprises,
a base member;
a plurality of first reflecting elements configured to form an array, supported by the base member, each configured to have a center portion that is spaced apart from the base member and forms space and to have a surface that is opposed to the base member and is reflective to reflect incident light, and provided with one or more open holes to pass incident light therethrough;
a second reflecting element located between the base member and the first reflecting elements to be spaced apart from the first reflecting elements, and configured to have a reflective surface for reflecting light incident through the open holes of the first reflecting elements; and
a plurality of actuation means for changing an amount of diffracted light, formed using light reflected from the first reflecting elements and the second reflecting element, by alternately moving center portions of corresponding first reflecting elements toward and from the base member in response to drive signals from the drive integrated circuit.

13. The mobile terminal as set forth in claim 12, wherein each of the first reflecting elements includes two or more open holes, longitudinal sides of which are arranged in a transverse direction of the base member.

14. The mobile terminal as set forth in claim 13, wherein a width of space between the first reflecting elements, a width of the open holes, a distance between the open hole, and a distance between an outermost open hole and the space between the first reflecting elements are similar.

15. The mobile terminal as set forth in claim 1, wherein the projection control system comprises:
an image input unit for receiving the image data from the control system;
an image data processing unit for processing and outputting the image data received by the image input unit; and
a drive signal control unit for receiving the internal display unit projection control signal from the control system, and, when the image data is received from the image data processing unit, producing a drive control signal based on the internal projection control signal and the image data, and outputting the drive control signal to the optical modulation system.

16. The mobile terminal as set forth in claim 1, wherein:
the control system outputs an external screen projection control signal used to display an image on an external screen, and outputs image data to be displayed on the external screen;
the projection control system receives the external screen projection control signal and the image data from the control system, and, in response to the input external screen projection control signal, outputs an external projection control signal and produces and outputs a drive control signal based on the image data; and
the optical modulation system produces the light and produces the image by modulating the produced light in response to the drive control signal from the projection control system, and scans the produced image onto the external screen by projecting the produced image onto the external screen in response to the external projection control signal from the projection control system.

17. The mobile terminal as set forth in claim 16, wherein the optical modulation system comprises:
a light source unit for producing and emitting light;
a drive integrated circuit for, when the drive control signal is input from the projection control system, producing and outputting a drive signal in response to the input drive control signal;
an optical modulator for, when the drive signal is input from the drive integrated circuit, operating and producing the image by modulating incident light in response to the input drive signal;
an illumination optical unit for causing the light, emitted from the light source unit, to enter the optical modulator;
a projection optical unit for projecting the image emitted from the optical modulator;
a scanning unit for producing a two-dimensional image by displaying the image, incident from the projection optical unit, on the internal display unit or the external screen; and
a light path changing unit for directing the image, produced by the optical modulator, to the internal display unit when the internal projection control signal is input from the projection control system, and directing the image, produced by the optical modulator, to the external screen when the external projection control signal is input from the projection control system.

18. The mobile terminal as set forth in claim 17, wherein the light source unit comprises:
a plurality of light sources for producing light having different colors; and
a condensing unit for condensing the light produced by the plurality of light sources.

19. The mobile terminal as set forth in claim 17, wherein the optical modulator produces a linear image by modulating the light incident from the illumination optical unit.

20. The mobile terminal as set forth in claim 17, wherein the optical modulator diffracts the light incident from the illumination optical unit using a diffractive optical modulator, thereby producing the image using the diffracted light.

21. The mobile terminal as set forth in claim 20, wherein the diffractive optical modulator produces a linear image by modulating the light incident from the illumination optical unit.

22. The mobile terminal as set forth in claim 21, further comprising a filter unit that is disposed downstream of the diffractive optical modulator on a light path extending from the light source unit to the internal display unit, and passes 0th-order diffracted light, selected from the diffracted light having a plurality of diffraction orders produced by the diffractive optical modulator, therethrough.

23. The mobile terminal as set forth in claim 17, wherein the light path changing unit comprises a reflective mirror for directing a light path to the internal display unit when the internal projection control signal is input from the projection control system, and directing the light path to the external screen when the external projection control signal is input from the projection control system.

24. The mobile terminal as set forth in claim 17, wherein the light path changing unit comprises:
a reflective mirror for changing a path of the diffracted light emitted from the diffractive optical modulator; and
a mirror moving unit for moving the reflective mirror to a location that changes the light path so that the light path is directed to the internal display unit when the internal projection control signal is input from the projection control system, and moves the reflective mirror to a location that changes the light path so that the light path is directed to the external screen when the external projection control signal is input from the projection control system.

25. The mobile terminal as set forth in claim 16, wherein the projection control system comprises:
an image input unit for receiving the image data from the control system;
an image data processing unit for processing and outputting the image data received by the image input unit; and
a drive signal control unit for outputting the internal projection control signal to the optical modulation system when the internal display unit projection control signal is received from the control system, outputting the external projection control signal to the optical modulation system when the external display unit projection control signal is received from the control system, producing the drive control signal based on the image data received from the image data processing unit, and outputting the drive control signal to the optical modulation system.

26. The mobile terminal as set forth in claim 1, wherein the internal display unit comprises an external window for displaying the light, projected from the optical modulation system, to an outside.

27. The mobile terminal as set forth in claim 26, wherein:
the internal display unit further comprises an internal display unit reflective mirror that is disposed on one side of the external window to face a side surface of the external window; and
the internal display unit reflective mirror projects the light, entering from the optical modulation system, onto the external window by reflecting the light to the external window, and the external window displays the light, reflected from the internal display unit reflective mirror, to an outside.

28. The mobile terminal as set forth in claim 26, wherein the internal display unit further comprises a wave guide that is formed on one side of the external window, includes a transmissive sidewall configured to pass incident light having an angle equal to or larger than a critical angle therethrough and a reflective sidewall formed to face the transmissive sidewall and to totally reflect incident light, and is provided with an opening facing the optical modulation system;
wherein, when the optical modulation system causes light to enter the opening of the wave guide while changing incident angle, the transmissive sidewall passes the incident light therethrough in a waveguiding direction of the wave guide so that the incident light is scanned onto the external window, thereby displaying an image on the external window.

29. The mobile terminal as set forth in claim 28, wherein the external window and the transmissive sidewall of the wave guide are integrated with each other.
